(19) United States
(12) Patent Application Publication
(10) Pub. No.: US 2021/0208589 A1
(43) Pub. Date: Jul. 8, 2021

(54) SELF-DRIVING SYSTEMS AND METHODS

(71) Applicant: LINGDONG TECHNOLOGY (BEIJING) CO. LTD, Beijing (CN)

(72) Inventor: Ou QI, Beijing (CN)

(21) Appl. No.: 16/792,546

(22) Filed: Feb. 17, 2020

(30) Foreign Application Priority Data
Jan. 7, 2020 (CN) 202010012417.5

(51) Int. Cl. G05D 1/02; G05D 1/00; A45C 5/03; A45C 5/14; A45C 13/26

(52) U.S. Cl. CPC G05D 1/0212; G05D 1/0088; G05D 1/0231; G01C 21/3602; A45C 5/03; A45C 5/14; A45C 13/262; G05D 1/0285

(57) ABSTRACT

Aspects of the present disclosure relate to self-driving luggage methods, systems, devices, and components thereof, having multiple operational modes. In one implementation, a self-driving system includes a piece of luggage. The piece of luggage includes one or more motorized wheels. The self-driving system includes a central processing unit configured to switch between a following mode and a leading mode. In the following mode the central processing unit instructs the piece of luggage to follow a user. In the leading mode the central processing unit instructs the piece of luggage to lead the user to a destination.

### BACKGROUND

### Field

Aspects of the present disclosure relate to self-driving luggage methods, systems, devices, and components thereof, having multiple operational modes.

### Description of the Related Art

Passengers in airports can experience problems and time delays. For example, it can be difficult and time-consuming for passengers to find specific locations within an airport, such as a boarding gate. Such issues can also cause passengers to miss connecting flights.

Therefore, there is a need for new and improved self-driving luggage systems that are able to assist passengers in finding and arriving at specific locations within airports.

### SUMMARY

Aspects of the present disclosure relate to self-driving luggage methods, systems, devices, and components thereof, having multiple operational modes.

In one implementation, a self-driving system includes a piece of luggage. The piece of luggage includes one or more motorized wheels. The self-driving system includes a central processing unit configured to switch between a following mode and a leading mode. In the following mode the central processing unit instructs the piece of luggage to follow a user. In the leading mode the central processing unit instructs the piece of luggage to lead the user to a destination.

In one implementation, a method of operating a self-driving system includes defaulting to a following mode for a piece of luggage. The method also includes determining if one or more leading requirements are met for a leading mode. The method also includes starting the leading mode. The method also includes moving the piece of luggage toward a destination.

### BRIEF DESCRIPTION OF THE DRAWINGS

So that the manner in which the above recited features of the present disclosure can be understood in detail, a more particular description of the present disclosure, briefly summarized above, may be had by reference to implementations, some of which are illustrated in the appended drawings. It is to be noted, however, that the appended drawings illustrate only common implementations of the present disclosure and are therefore not to be considered limiting of its scope, for the present disclosure may admit to other equally effective implementations.

FIG. 1A illustrates a schematic isometric left-side view of a self-driving system, according to one implementation.

FIG. 1B illustrates a schematic isometric right-side view of the self-driving system illustrated in FIG. 1A, according to one implementation.

FIG. 1C is an enlarged schematic view of a handle of the self-driving system illustrated in FIGS. 1A and 1B, according to one implementation.

FIG. 1D illustrates a schematic view of respective distances to a closer first target and a farther second target relative to cameras and laser emitters of a self-driving system, according to one implementation.

FIG. 2A illustrates a schematic top view of the self-driving system monitoring a proximity of a user in a vision monitoring mode, according to one implementation.

FIG. 2B is an enlarged view of an image of a target taken by a camera of the self-driving system, according to one implementation.

FIG. 2C illustrates a side schematic view of the self-driving system monitoring a proximity of the user in a radio wave monitoring mode, according to one implementation.

FIG. 3 illustrates a schematic view of the self-driving system illustrated in FIGS. 1A-1C, according to one implementation.

FIG. 4A is a schematic illustration of a map of an airport, according to one implementation.

FIG. 4B is a schematic illustration of an image of the airport illustrated in FIG. 4A, according to one implementation.

FIG. 5A is a schematic illustration of a method of operating the self-driving system illustrated in FIGS. 1A-1C and 3, according to one implementation.

FIG. 5B is a schematic illustration of block 507 illustrated in FIG. 5A, according to one implementation.

FIG. 5C is a schematic illustration of a message that may be displayed on the user's cellular phone after the self-driving system is powered on, according to one implementation.

FIG. 5D is a schematic illustration of a prompt that may be displayed on the user's cellular phone, according to one implementation.

FIG. 5E is a schematic illustration of the self-driving system switching from the leading mode to the following mode while the self-driving system is in the vision monitoring mode, according to one implementation.

To facilitate understanding, identical reference numerals have been used, where possible, to designate identical elements that are common to the figures. It is contemplated that elements disclosed in one implementation may be beneficially utilized on other implementations without specific recitation.

### DETAILED DESCRIPTION

Aspects of the present disclosure relate to self-driving luggage methods, systems, devices, and components thereof, having multiple operational modes. Although the embodiments of the self-driving systems are described and illustrated herein with respect to a luggage system, the embodiments may be used with other types of portable equipment. Additionally, although the embodiments of the self-driving systems are described and illustrated herein with respect to an airport, the embodiments may be used with other types of facilities, such as an office or a factory.

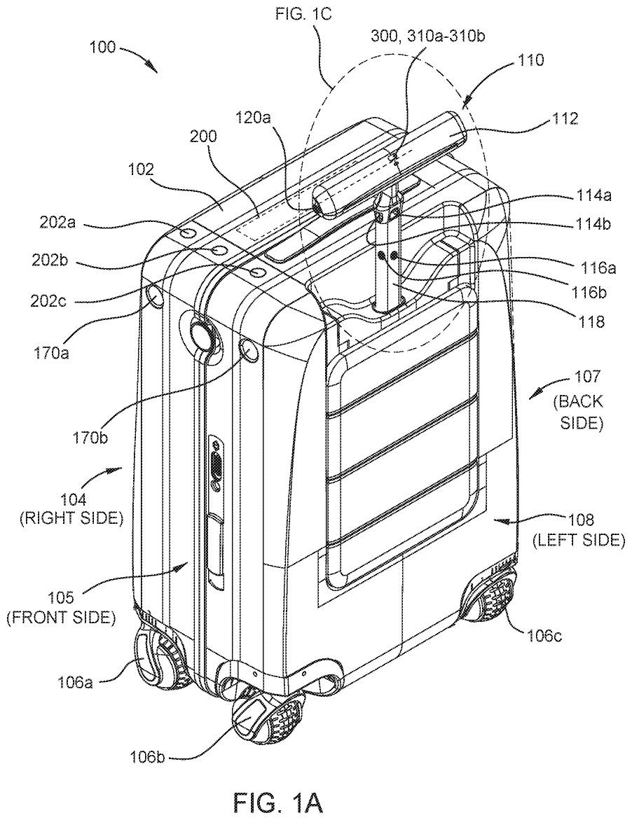

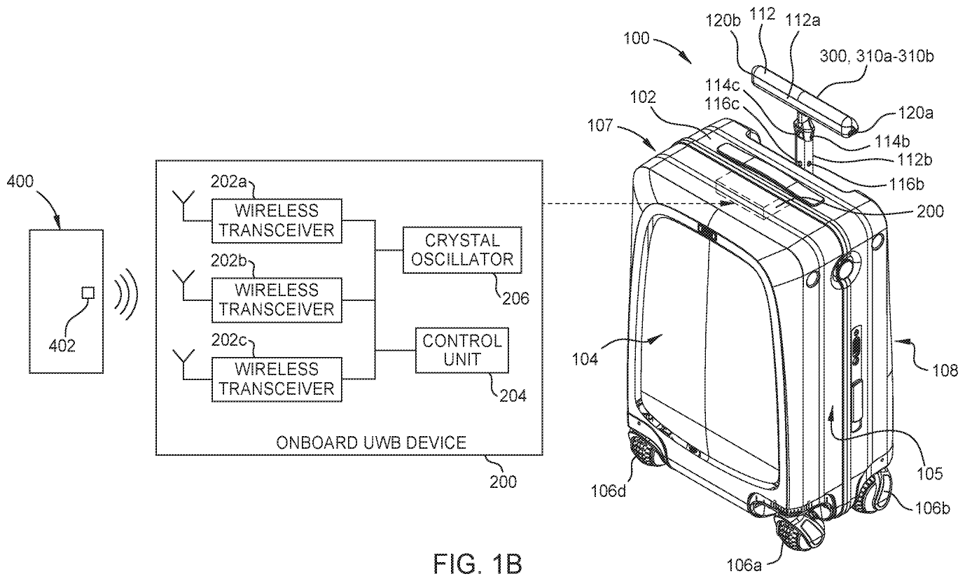

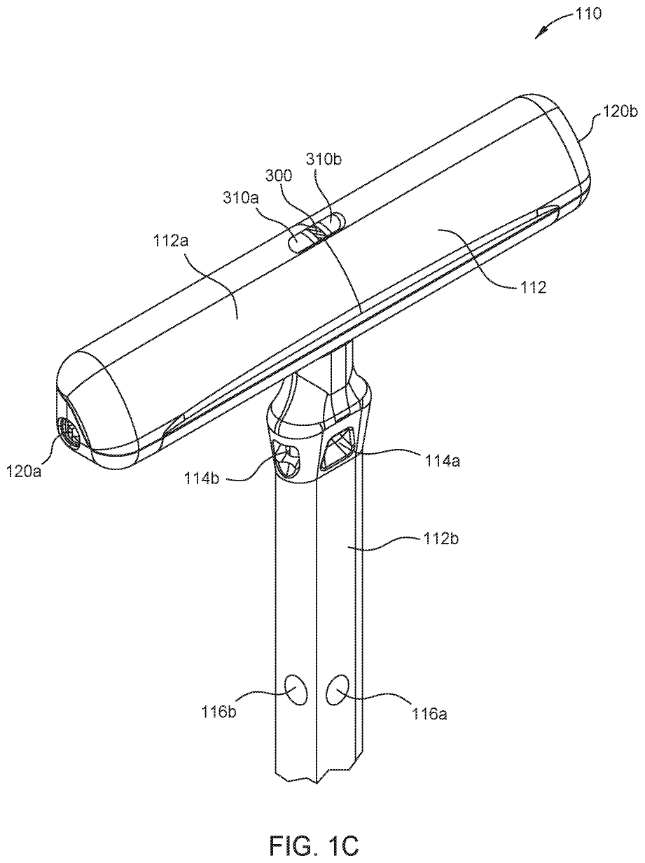

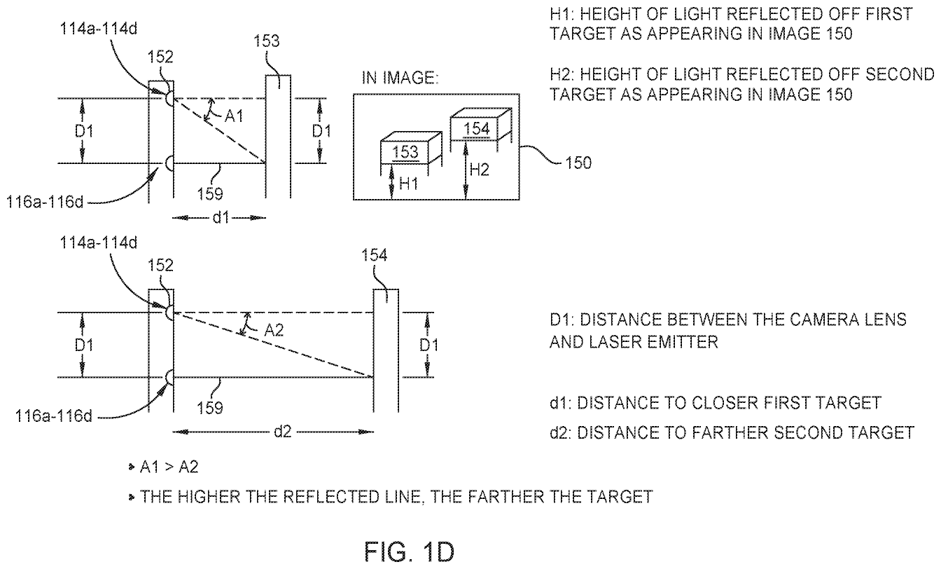

FIG. 1A illustrates a schematic isometric left-side view of a self-driving system 100, according to one implementation. The self-driving system 100 may be a smart luggage system. The self-driving system 100 includes a body in the form of a piece of luggage 102. The piece of luggage 102 may be a suitcase or travel case. The piece of luggage 102 is configured to store items and transport items. The piece of luggage 102 may be rectangular, square, hexagonal in shape, or any other shape suitable to store items for transport. The piece of luggage 102 includes a front side 105 and a back side 107. The self-driving system 100 includes one or more motorized wheels 106a-106d (four are shown in FIGS. 1A and 1B) coupled to the bottom of the piece of luggage 102. Each motorized wheel 106a-106d rotates and rolls in a given direction to move the piece of luggage 102. In one example, the luggage 102 is supported by two, three, four, or more motorized wheels, each configured to move the piece of luggage 102 in a given direction.

The self-driving system 100 includes a handle 110 coupled to the piece of luggage 102. The handle 110 is configured to allow a user of the self-driving system 100 to move, push, pull, and/or lift the piece of luggage 102. The handle 110 is located on a left side 108 of the luggage 102, but can be located on any side of the piece of luggage 102, such as on a right side 104 that opposes the left side 108. The handle 110 includes a pull rod 112 coupled to a connecting rod 118, which is coupled to the luggage 102. The pull rod 112 forms a “T” shape with, and telescopes within, the connecting rod 118. An upper portion 112a of the pull rod 112 is elongated and oriented horizontally and is perpendicular to a lower portion 112b of the pull rod 112. That is, the lower portion 112b of the pull rod 112 is oriented vertically and is perpendicular to the upper portion 112a.

One or more sensors 120a, 120b are disposed on the upper portion 112a of the pull rod 112. The sensors 120a, 120b are cameras configured to take photographs and/or videos of objects in a surrounding environment of the piece of luggage 102. In one example, the cameras 120a, 120b take photographs and/or videos of nearby targets and/or users. The one or more cameras 120a, 120b are disposed on one or more outer elongated portions of the pull rod 112, and face outwards from the piece of luggage 102. The first sensor 120a is a front camera 120a that faces the front side 105 of the piece of luggage 102. The second sensor 120b is a back camera 120b that faces the back side 107.

The self-driving system 100 includes one or more sensors 114a-114d (four are shown) disposed on one or more of the pull rod 112 and/or the connecting rod 118 of the handle 110. The sensors 114a-114d are cameras configured to take photographs and/or videos of objects in a surrounding environment of the piece of luggage 102. In one example, the cameras 114a-114d take photographs and/or videos of nearby targets and/or users. The cameras 114a-114d are disposed on the lower portion 112b of the pull rod 112. In one example, one of the four cameras 114a-114d is coupled to one of four sides of the lower portion 112b of the pull rod 112. Each of the four sides of the lower portion 112b corresponds to the left side 108, the right side 104, the front side 105, and the back side 107. A left side camera 114a faces the left side 108, a front camera 114b faces the front side 105, a right side camera 114c faces the right side 104, and a back camera 114d faces the back side 107.

The cameras 114a-114d and the cameras 120a, 120b are disposed on the pull rod 112 to facilitate reduced damage to the cameras in case of the piece of luggage 102 colliding with an object, for example when the pull rod 112 is retracted into the piece of luggage 102.

Each of the cameras 114a-114d is configured to take images of a target, such as a user, so that the self-driving system 100 can determine a distance of the target relative to the piece of luggage 102. Each of the cameras 114a-114d may include a wide-angle lens. Images taken by a camera 114a-114d include one or more targets such that the larger a target appears in the image, the farther it is from the piece of luggage 102 and the camera 114a-114d that took the image.

The self-driving system 100 includes one or more laser emitters 116a-116d disposed on the lower portion 112b of the pull rod 112 and below the cameras 114a-114d. Each of the four laser emitters 116a-116d corresponds to one of the four cameras 114a-114d. Each laser emitter 116a-116d is disposed on the same side of the lower portion 112b of the pull rod 112 as the corresponding one of the cameras 114a-114d. Each laser emitter 116a-116d is disposed on one of the four sides of the lower portion 112b of the pull rod 112. Each of the laser emitters 116a-116d is configured to shoot light, such as lasers, in an outward direction from the lower portion 112b of the pull rod 112 and towards one or more targets, such as a user. The light emitted by the laser emitters 116a-116d reflects off of the one or more targets. The light emitted by the laser emitters 116a-116d is invisible to the human eye. Each of the cameras 114a-114d includes an optical filter to identify the light emitted from the laser emitters 116a-116d and reflected off of a target to facilitate determining the proximity of the target relative to the piece of luggage 102. The cameras 114a-114d are configured to take an image of a target that includes light emitted from a respective one of the laser emitters 116a-116d that is reflected off of the target. Images taken by a camera 114a-114d include one or more targets and reflected light such that the higher the reflected light appears in the image, the farther the target is from the piece of luggage 102 and the camera 114a-114d that took the images.

As shown in FIG. 1D, a first angle A1 at which light 159 (emitted from one or more of laser emitters 116a-116d and reflected off of a first target 153) is detected relative to a camera lens 152 (of one or more of the cameras 114a-114d) is greater for the first target 153 that is closer to the cameras 114a-114d than a second angle A2 at which the light 159 is detected by the camera lens 152 for a second target 154 that is farther from the cameras 114a-114d. The cameras 114a-114d and the laser emitters 116a-116d are located at a fixed distance D1 relative to each other. The first angle A1 is greater than the second angle A2, which indicates that a distance d1 of the first target 153 relative to the cameras 114a-114d is less than a distance d2 of the second target 154 relative to the cameras 114a-114d. Also, the light 159 reflected off of the first target 153 will appear in the image 150 at a height H1 that is less than a height H2 of the light 159 reflected off of the second target 154 since the first target 153 is closer to the cameras 114a-114d than the second target 154.

The self-driving system 100 includes one or more proximity sensors 170a, 170b disposed on the piece of luggage 102. Two proximity sensors 170a, 170b are shown coupled to a side of the luggage 102 adjacent to a top end of the piece of luggage 102. Any number of proximity sensors 170a, 170b can be used and located at different positions and/or on any side of the piece of luggage 102. The proximity sensors 170a, 170b are configured to detect the proximity of one or more objects. In one example, the proximity sensors 170a, 170b detect the proximity of a user. In one example, the proximity sensors 170a, 170b detect the proximity of objects (e.g., obstacles) other than the user to facilitate the piece of luggage 102 avoiding the objects as the piece of luggage 102 follows and/or leads the user.

The proximity sensors 170a, 170b include one or more of ultrasonic sensors, sonar sensors, infrared sensors, radar sensors, and/or LiDAR sensors. The proximity sensors 170a, 170b may work with the cameras 120a, 120b, the lower cameras 114a-114d, and/or the laser emitters 116a-116d to facilitate the piece of luggage 102 avoiding obstacles (such as objects other than the user) as the piece of luggage 102 follows and/or leads the user. Obstacles may include other people or objects in the travel path of the luggage 102 when moving in a rear following position, a side following position, or a front leading position relative to the user. When an obstacle is identified, the self-driving system 100 will take corrective action to move the piece of luggage 102 and avoid a collision with the obstacle based on the information received from the self-driving system 100 components, such as one or more of the proximity sensors 170a, 170b, the cameras 120a, 120b, the lower cameras 114a-114d, and/or the laser emitters 116a-116d.

FIG. 1B illustrates a schematic isometric right-side view of the self-driving system 100 illustrated in FIG. 1A, according to one implementation. The self-driving system 100 includes an onboard ultra-wideband (“UWB”) device 200 and a mobile ultra-wideband device 400. The onboard ultra-wideband device 200 is disposed on the piece of luggage 102. In one example, the onboard ultra-wideband device 200 is located inside and on a top end of the piece of luggage 102 to continuously communicate with a transmitter 402 of the mobile ultra-wideband device 400. The onboard ultra-wideband device 200 is located on the top end of the piece of luggage 102 and closer toward the right side 104 of the piece of luggage 102 (the side opposite from the handle 110) rather than the left side 108. In one example, the onboard ultra-wideband device 200 is secured within a plastic housing that is coupled to the inside of the luggage 102 at the top end on the front side 105.

The onboard ultra-wideband device 200 has a positioning device that includes a control unit 204 and one or more transceivers 202a, 202b, 202c (three are shown). In one example, the control unit 204 is a central processing unit. The onboard ultra-wideband device 200 includes a crystal oscillator 206. The crystal oscillator 206 is an electronic oscillator circuit that uses the mechanical resonance of a vibrating crystal of piezoelectric material to create an electric signal. The electric signal has a frequency that is used to keep track of time to provide a stable clock signal. The transceivers 202a, 202b, 202c share the same crystal oscillator 206 so that they each have the exact same stable clock signal. In one example, the transceivers 202a, 202b, 202c determine from which side a transmitter 402 of a mobile ultra-wideband device 400 is located by calculating the time difference of arrival based on the arrival time of the signal from the transmitter 402 as detected by each one transceiver 202a, 202b, 202c relative to each other transceiver 202a, 202b, 202c. The one or more transceivers 202a, 202b, 202c may be antennas configured to receive one or more signals, such as radio wave signals, from the mobile ultra-wideband device 400. The one or more transceivers 202a, 202b, 202c may be disposed within the onboard ultra-wideband device 200 (as illustrated in FIG. 1B). In one example, the one or more transceivers 202a-202c may be coupled to a top of the piece of luggage 102 (as illustrated in FIG. 1A).

In one embodiment, which can be combined with other embodiments, the onboard ultra-wideband device 200 determines the angle of arrival of a signal transmitted by the transmitter 402 of the mobile ultra-wideband device 400 to determine the position of a user relative to the luggage 102. The control unit 204 and the crystal oscillator 206 continuously calculate the angle at which the transmitter 402 is located relative to two of the three transceivers 202a, 202b, and 202c. The self-driving system 100 is configured to determine the position of the piece of luggage 102 relative to the mobile ultra-wideband device 400 using (1) the proximity of the transmitter 402 as continuously calculated by the onboard ultra-wideband device 200 using the angle of arrival calculation, and (2) the location of the transmitter 402 as continuously calculated by the onboard ultra-wideband device 200 using the time difference of arrival calculation. When a user includes or wears the mobile ultra-wideband device 400, the self-driving system 100 is configured to determine a position of the piece of luggage relative to the user. In one example, a user wears the mobile ultra-wideband device 400 on a waist of the user, such as on a belt of the user. In one example, a user wears the mobile ultra-wideband device 400 on an arm of the user, such as on a wrist of the user.

In one example, the transmitter 402 is integrated into the mobile ultra-wideband device 400. The transmitter 402 may be in the form of hardware disposed within the mobile ultra-wideband device 400 and/or software programmed into the mobile ultra-wideband device 400. In FIG. 1B, the mobile ultra-wideband device 400 may be a user-wearable belt clip device, a cellular phone, a tablet, a computer, and/or any other device that can communicate with the onboard ultra-wideband device 200 (such as by using a transmitter 402).

FIG. 1C is an enlarged schematic view of the handle 110 illustrated in FIGS. 1A and 1B, according to one implementation. The handle 110 includes a status indicator 300 and one or more infrared sensors 310a, 310b (two are shown). The status indicator 300 and the infrared sensors 310a, 310b are disposed adjacent to an upper end of the upper portion 112a of the pull rod 112 and adjacent to a center of the upper portion 112a of the pull rod 112. The status indicator 300 is disposed adjacent to, and between, the two infrared sensors 310a, 310b. The status indicator 300 includes a light-emitting diode (LED). The infrared sensors 310a, 310b are disposed to detect a hand of a user when the hand is close to, or gripping, the upper portion 112a of the pull rod 112 of the handle 110.

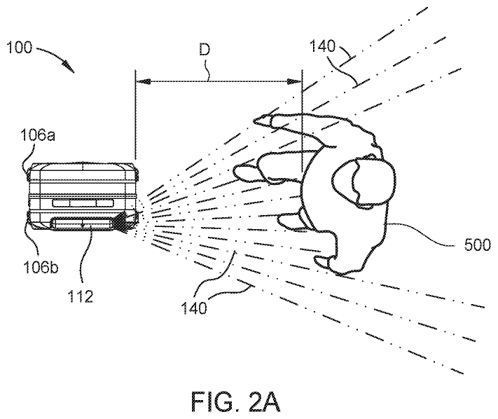

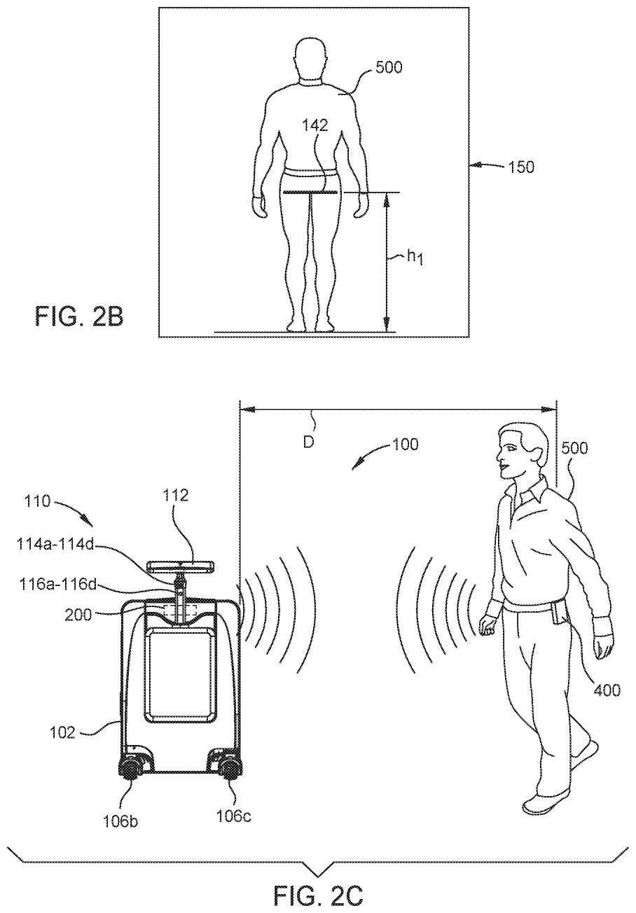

FIG. 2A illustrates a schematic top view of the self-driving system 100 monitoring a proximity of a user 500 in a vision monitoring mode, according to one implementation. FIG. 2B is an enlarged view of an image 150 of a target, in this case the user 500, taken by a camera of the self-driving system 100, according to one implementation. The self-driving system 100 is configured to switch between a vision monitoring mode and a radio wave monitoring mode for monitoring a proximity of the user 500 relative to the piece of luggage 102.

When the self-driving system 100 is in the vision monitoring mode, one or more laser emitters 116a-116d emit one or more flat beams of light 140 towards a user 500. The wavelength of the flat beams of light 140 (such as laser beams) emitted by the laser emitters 116a-116d is within a range of 800 nm to 815 nm, such as 803 nm to 813 nm. The one or more of the cameras 114a-114d and/or one or more of the cameras 120a, 120b take one or more images of the user 500. The one or more beams of light 140 reflect off of the user 500 as a horizontal line 142 and at a height h₁, as illustrated in the image 150. The one or more images, such as the image 150, taken by the cameras 114a-114d include the user 500 and the horizontal line 142 of light reflected off of the user 500. The one or more cameras 114a-114d and/or the one or more cameras 120a, 120b continuously take images of the user 500 and the surrounding environment of the piece of luggage 102.

The image 150 includes the horizontal line 142 of light being reflected off of the user 500. The horizontal line 142 of light reflected off of the user 500 includes the height h₁. In the vision monitoring mode, the self-driving system 100 determines a distance D (illustrated in FIG. 2A) of the user 500 relative to the piece of luggage 102 by calculating the height h₁ of the horizontal line 142 of light reflected off of the user 500, as illustrated in the image 150. The higher the height h₁ is in the image 150, the farther the user 500 is from the piece of luggage 102.

In response to the images taken by the cameras 114a-114d, the self-driving system 100 instructs one or more motorized wheels 106a-106d to move the luggage 102 in a given direction, such as in a given direction towards the user 500 or in a given direction towards a destination. In an example where the position of the user 500 relative to the piece of luggage 102 is determined by the self-driving system 100, the self-driving system 100 will continuously monitor and follow and/or lead the user 500 in a rear following position, a side following position, or a front leading position. In one embodiment, which can be combined with other embodiments, the laser emitters 116a-116d emit light towards a plurality of targets (such as the user 500 and an object). The self-driving system 100 instructs the piece of luggage 102 to follow the target (such as the user 500) that has the smallest height of a horizontal line of reflected light off of that target (such as the height h₁ of the horizontal line 142 that is less than a height of an object, such as an obstacle). In one example, the self-driving system 100 instructs the one or more motorized wheels 106a-106d to move the luggage 102 in a given direction towards the target having the smallest height of a horizontal line of reflected light off of that target.

FIG. 2C illustrates a side schematic view of the self-driving system 100 monitoring a proximity of the user 500 in a radio wave monitoring mode, according to one implementation. The user 500 is wearing the mobile ultra-wideband device 400 on a belt of the user 500. The mobile ultra-wideband device 400 is a user-wearable belt clip device. In one example, the mobile ultra-wideband device 400 includes a belt clip attached to the waist of the user 500, such as a belt clip attached to the belt of the user 500. When the self-driving system 100 is in the radio wave monitoring mode, the onboard ultra-wideband device 200 and the mobile ultra-wideband device 400 communicate and the onboard ultra-wideband device 200 determines a position of the user 500 relative to the piece of luggage 102 using the angle of arrival and timing mechanisms described above. In one example, the onboard ultra-wideband device 200 continuously receives information regarding the position of the user 500 from the mobile ultra-wideband device 400.

The self-driving system 100 uses the position of the user 500 relative to the piece of luggage 102 to calculate the distance D between the user 500 and the piece of luggage 102. In response to the information received by the onboard ultra-wideband device, the self-driving system 100 may instruct one or more motorized wheels 106a-d to move the luggage 102 in a given direction.

The self-driving system 100 is configured to switch between a following mode and a leading mode. In the following mode, the self-driving system 100 instructs the motorized wheels 106a-106d to move the piece of luggage 102 in a given direction towards the user 500. In the following mode, the piece of luggage 102 follows the user 500. In the leading mode, the self-driving system 100 instructs the motorized wheels 106a-106d to move the piece of luggage 102 in a given direction towards a destination, such as a location within an airport, for example a boarding gate in an airport. In the leading mode, the piece of luggage 102 leads the user 500 such that the user 500 may follow the piece of luggage 102.

In each of the following mode and the leading mode, the self-driving system 100 may be in the vision monitoring mode or the radio wave monitoring mode. FIGS. 2A and 2C illustrate the self-driving system 100 in the leading mode to lead the user 500.

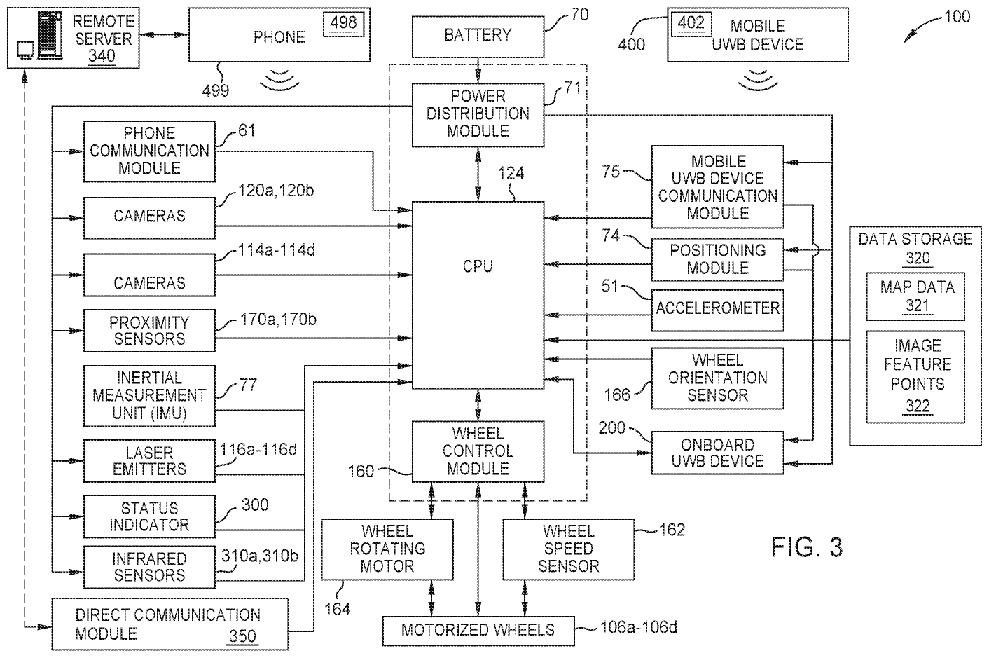

FIG. 3 illustrates a schematic view of the self-driving system 100 illustrated in FIGS. 1A-1C, according to one implementation. The self-driving system 100 includes a battery 70 in communication with a power distribution module 71. The power distribution module 71 distributes power supplied by the battery 70 to the components of the self-driving system 100. The self-driving system 100 includes a central processing unit (“CPU”) 124. The CPU 124 is in communication with a phone communication module 61 and a mobile ultra-wideband device communication module 75. In one example, a mobile ultra-wideband device 400 having a transmitter 402 is used to communicate with the mobile ultra-wideband device communication module 75. In one example, a cellular phone 499 having a transmitter 498 is used to communicate with the phone communication module 61.

The cellular phone 499 is used by the user 500 described above and below. The transmitter 498 is configured to transmit ultra-wideband signals. Both the mobile ultra-wideband device 400 having a transmitter 402 and the cellular phone 499 having a transmitter 498 may communicate with the communication modules 61, 75, respectively, via ultra-wideband, radio frequency identification (active and/or passive), Bluetooth (low energy), WiFi, and/or any other form of communication known in the art. The cellular phone 499 and the mobile ultra-wideband device 400 are configured to receive information from the CPU 124 regarding the operation of the self-driving system 100. The mobile ultra-wideband device communication module 75 and the phone communication module 61 may each be a separate unit from, or integrated into, the onboard ultra-wideband device 200. The cellular phone 499 may perform one or more of the same functions as the mobile ultra-wideband device 400.

The CPU 124 is configured to switch between the following mode and the leading mode, each of which is discussed above. The CPU 124 defaults to the following mode. The CPU 124 of the self-driving system 100 is configured to switch between the vision monitoring mode and the radio wave monitoring mode, each of which is discussed above.

When the self-driving system 100 is in the vision monitoring mode, the CPU 124 is configured to receive from the one or more cameras 114a-114d one or more images (such as image 150) of a target (such as user 500) that include the light reflected off of the target (such as the horizontal line 142 of light that is reflected off of the user 500). In response to receiving the images from the one or more cameras 114a-114d, the CPU 124 is configured to determine a distance (such as the distance D) to the target based on a height (such as the height h₁) at which the light emitted by a laser emitter 116a-116d is reflected off of the target. The CPU 124 is configured to generate instructions regarding a position of the piece of luggage 102 in relation to the user 500 using the distance D and/or the first height h₁. The present disclosure contemplates that the self-driving system 100 described throughout the present disclosure may include a graphics processing unit (GPU) that includes one or more of the aspects, features, and/or components of the CPU 124 described throughout the present disclosure. The self-driving system 100 may include a GPU that performs one or more of the functions performed by the CPU 124 described throughout the present disclosure. As an example, the self-driving system 100 may include a GPU that is configured to receive from the one or more cameras 114a-114d one or more images (such as image 150) of a target (such as user 500) that include the light reflected off of the target, when the self-driving system 100 is in the vision monitoring mode.

When in the radio wave monitoring mode, the CPU 124 receives information from one or more of the onboard ultra-wideband device 200 (such as from the control unit 204) and/or the mobile ultra-wideband device 400 regarding a position of the mobile ultra-wideband device 400 relative to the piece of luggage 102. The CPU 124 uses the information regarding the position of the mobile ultra-wideband device 400 relative to the piece of luggage 102 to determine a distance (such as the distance D) between the piece of luggage 102 and the mobile ultra-wideband device 400. The CPU 124 is configured to generate instructions regarding a position of the piece of luggage 102 in relation to the user 500 using the information regarding the position of the mobile ultra-wideband device 400 relative to the piece of luggage 102 and/or the determined distance between the piece of luggage 102 and the mobile ultra-wideband device 400.

In one example, the CPU 124 and the control unit 204 of the onboard ultra-wideband device 200 are separate units. In one example, the CPU 124 and the control unit 204 are integrated into a single processing unit disposed on the piece of luggage 102. In one example, the CPU 124 and the onboard ultra-wideband device 200 are separate units. In one example, the CPU 124 and the onboard ultra-wideband device 200 are integrated into a single processing unit disposed on the piece of luggage 102.

The CPU 124 sends the generated instructions regarding the position of the piece of luggage 102 in relation to the user 500 to a wheel control module 160. In the following mode the CPU 124 generates and sends instructions for the wheel control module 160 to move the piece of luggage 102 in a given direction at a given speed towards the user 500. In the leading mode the CPU 124 generates and sends instructions for the wheel control module 160 to move the piece of luggage 102 in a given direction at a given speed towards the destination at the airport at which the piece of luggage 102 is located.

Upon receiving instructions from the CPU 124, the wheel control module 160 is configured to control the direction and/or speed of the piece of luggage 102 relative to the user 500 and/or the surrounding environment based on the instructions received from the CPU 124. The wheel control module 160 communicates with a wheel speed sensor 162 and a wheel rotating motor 164. The wheel control module 160 also communicates information regarding the one or more motorized wheels 106a-106d to the CPU 124. Although only one wheel control module 160 is show, each of the one or more motorized wheels 106a-106d may include a separate wheel control module 160 in communication with the CPU 124. Each of the one or more motorized wheels 106a-106d may include a separate wheel rotating motor 164. In one example, the wheel control module 160 can be integrated into the CPU 124 as a single processing unit. In one example, the CPU 124 includes a single wheel control module 160 to control each of the one or more motorized wheels 106a-106d.

The wheel control module 160 controls the direction and/or speed of the piece of luggage 102 by increasing, decreasing, or stopping power supplied to one or more of the motorized wheels 106a-106d and/or by controlling the direction of the one or more motorized wheels 106a-106d with the wheel rotating motor 164. In one example, one or more of the power distribution module 71, the CPU 124, the onboard ultra-wideband device 200, and the wheel control module 160 are integrated into a single processing unit coupled to the luggage 102.

A positioning module 74 communicates information regarding the position of the luggage 102 to the CPU 124, the onboard ultra-wideband device 200, and/or the user 500 (via the cellular phone 499 and/or the mobile ultra-wideband device 400 for example). The positioning module 74 may be a separate unit or integrated into the onboard ultra-wideband device 200. The positioning module 74 may include one or more of a computer vision based module, GPS module, 4G module, 5G module, WiFi module, iBeacon module, Zigbee module, and/or Bluetooth module so that the user 500 can find the location of the self-driving system 100 at any time, such as in the event that the self-driving system 100 is lost.

An accelerometer 51 is configured to communication information regarding the overall acceleration and/or speed of the self-driving system 100 to the CPU 124. A wheel orientation sensor 166 is configured to communicate information regarding the orientation of the one or more motorized wheels 106a-106d to the CPU 124. The CPU 124 is also in communication with an inertial measurement unit (IMU) 77, and the proximity sensors 170a, 170b. The IMU 77 communicates information regarding the dynamic movements of the self-driving system 100, such as the pitch, roll, yaw, acceleration, and/or angular rate of the self-driving system 100 to the CPU 124. In one example, when the IMU 77 detects that the self-driving system 100 is tilting or about to fall over, the CPU will instruct a wheel control module 160 to cut power to one or more of the motorized wheels 106a-106d to prevent the self-driving system from falling over. The proximity sensors 170a, 170b are configured to communicate information regarding the presence of targets near the self-driving system 100 to the CPU 124.

The CPU 124 is in communication with the status indicator 300 and the one or more infrared sensors 310. The CPU 124 is configured to generate instructions regarding a status of the piece of luggage 102. The status of the piece of luggage 102 is determined by the CPU 124 based on information received from the various components (e.g., one or more of cameras 120a, 120b, proximity sensors 170a, 170b, cameras 114a-114d, laser emitters 116a-116d, the various modules 61, 74, 75, 160, the mobile ultra-wideband device 400, and/or the onboard ultra-wideband device 200) of the self-driving system 100. The CPU 124 is configured to automatically switch to a manual pull mode when the infrared sensors 310a, 310b (illustrated in FIG. 1C) detect a hand of the user 500 when the hand is close to, or gripping, the upper portion 112a of the pull rod 112 of the handle 110. In response to detecting a hand, the infrared sensors 310a, 310b send one or more signals to the CPU 124. In one example, the infrared sensors 310a, 310b detect light obstruction and/or heat signals from the hand of a user 500.

The self-driving system 100 includes a data storage 320. The data storage 320 stores data, such as data relating to the airport at which the piece of luggage 102 is located. The data storage 320 stores map data 321 relating to a map of the airport. The data storage 320 also stores a plurality of image feature points 322 for the airport.

The self-driving system 100 includes a remote server 340. The remote server 340 may include data regarding the airport at which the piece of luggage 102 is located, such as map data relating to the map of the airport and a plurality of image feature points for the airport. The remote server 340 may also emit radio wave signals. The self-driving system 100 includes a direct communication module 350. The direct communication module 350 may include one or more of a computer vision based module, GPS module, 4G module, 5G module, WiFi module, iBeacon module, Zigbee module, and/or Bluetooth module. The CPU 124 may communicate with the remote server 340 using the cellular phone 499 and/or the direct communication module 350. In one example, data and/or radio wave signals are sent from the remote server 340 to the cellular phone 499 of the user 500, and then relayed through the phone communication module 61 to the CPU 124. In one example, the data and/or radio wave signals are sent from the remote server 340 to the direct communication module 350, and then relayed to the CPU 124. Data received from the remote server 340, such as map data and image feature points, may be stored in the data storage 320.

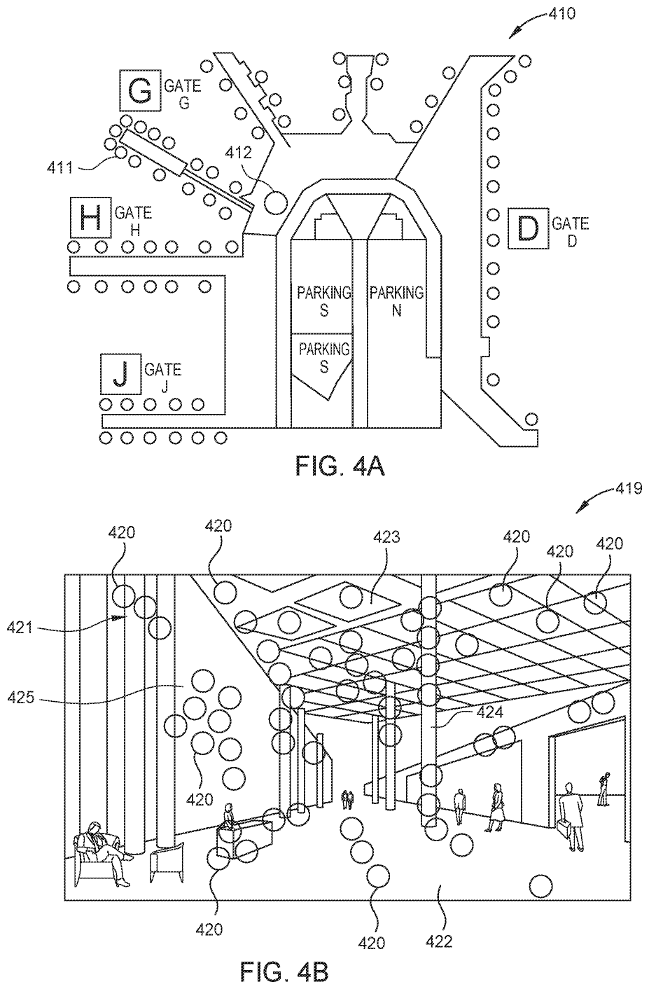

FIG. 4A is a schematic illustration of a map 410 of an airport, according to one implementation. The map 410 includes a first location 411 that may be, for example, a boarding gate of the airport. The first location 411 may be the destination to which the self-driving system 100 is leading the user 500 when in the leading mode. The map 410 includes a second location 412. The second location 412 may be, for example, a current location of the piece of luggage 102 located at the airport. The map data provided by the remote server 340 and/or stored by the data storage 320 relates to various locations of the map 410 of the airport, such as the first location 411 and the second location 412.

FIG. 4B is a schematic illustration of an image 419 of the airport illustrated in FIG. 4A, according to one implementation. The image 419 may be taken by, for example, the cameras 120a, 120b and/or the cameras 114a-114d. The image 419 includes a plurality of image feature points 420 associated with different items at a given location of the map 410 of the airport. The plurality of image feature points 420 may relate to items at a given location such as a storefront 421, a floor 422, a ceiling 423, structural beams 424, and/or a window 425.

In one example, the image 419 is taken at the current location of the piece of luggage 102. The plurality of image features points 420 are associated with a set of the plurality of image feature points stored in the data storage 320 and/or provided by the remote server 340 to determine the current location of the piece of luggage. In one example, the CPU 124 associates the plurality of image feature points 420 of the image 419 with the plurality of image feature points stored in the data storage 320 that correspond to the second location 412. The CPU 124 hence determines that the current location of the piece of luggage 102 is at the second location 412.

Images 419 may be taken along a path from the current location (e.g., the second location 412) to the destination (e.g., the first location 411) to determine if the image feature points along the path correspond to the plurality of image feature points 322 stored in the data storage 320 for locations along the path.

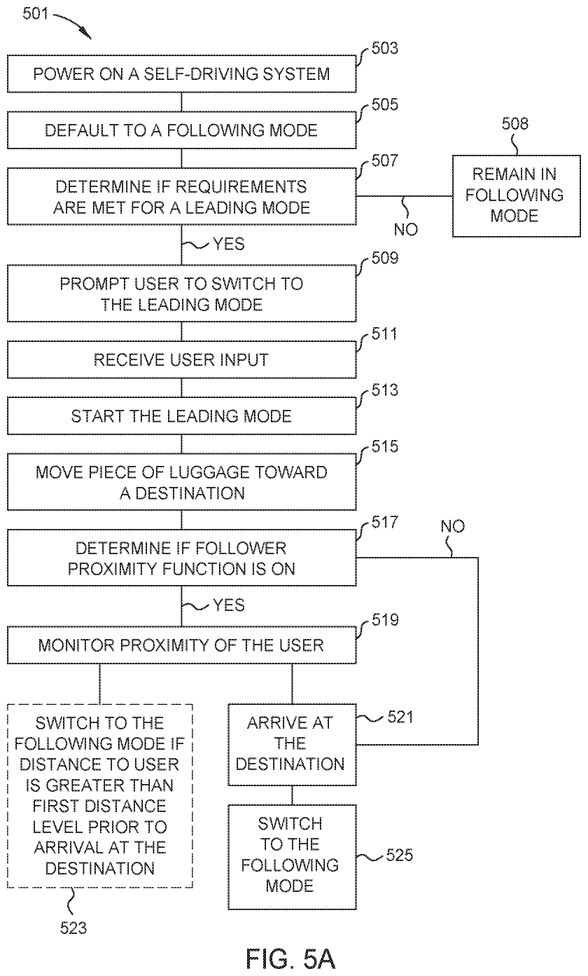

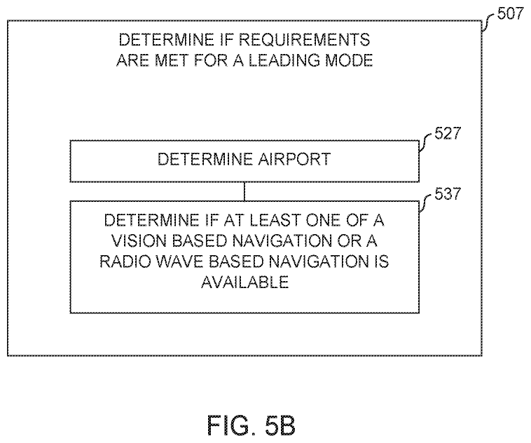

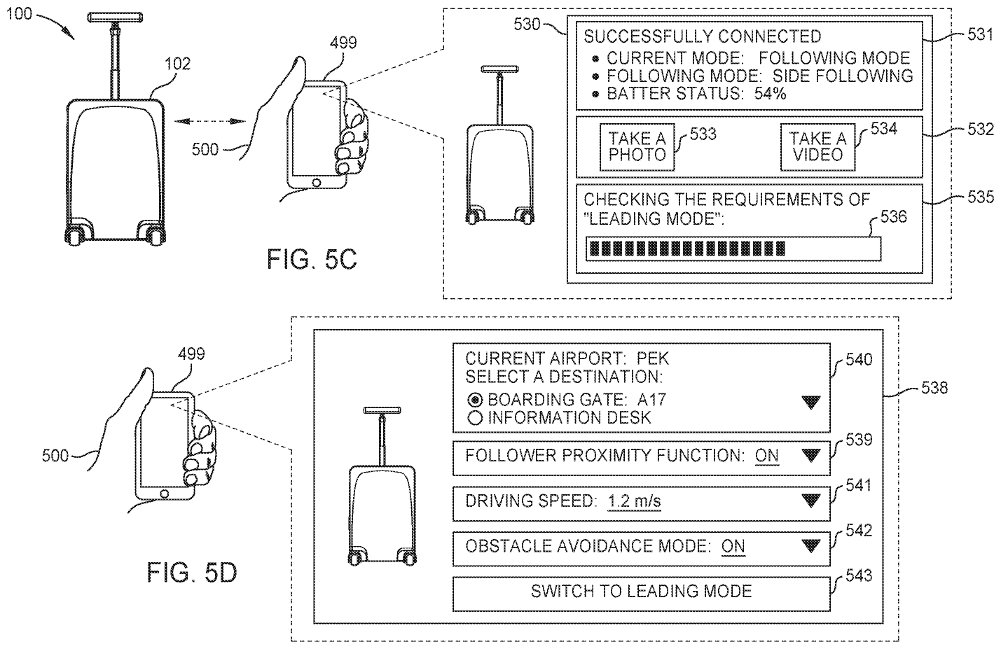

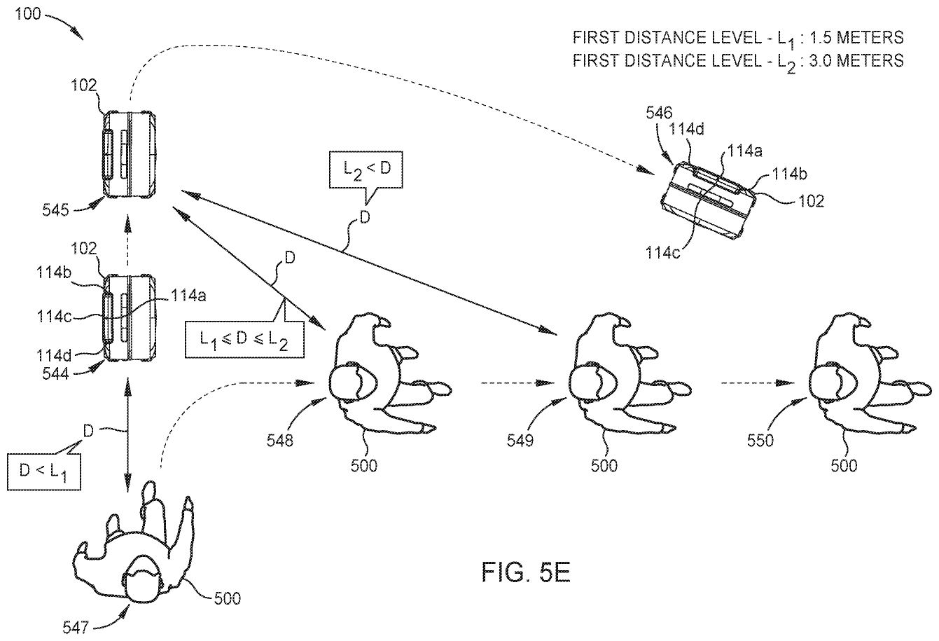

FIG. 5A is a schematic illustration of a method 501 of operating the self-driving system 100 illustrated in FIGS. 1A-1C and 3, according to one implementation. At block 503, the self-driving system 100 is powered on. At block 505, the self-driving system 100 defaults to a following mode. In the following mode, the CPU 124 of the self-driving system 100 instructs the piece of luggage 102 to follow the user 500. At block 507, the CPU 124 determines if one or more leading requirements are met for a leading mode of the self-driving system 100. If the one or more leading requirements are not met, then the self-driving system 100 remains in the following mode at block 508 and a message is displayed on the cellular phone 499 to the user 500 that the leading mode is not currently supported.

If the one or more leading requirements are met, then the self-driving system 100 prompts the user 500 to switch to the leading mode at block 509. The self-driving system 100 prompts the user 500 by sending a prompt to the user's cellular phone 499. A message is also displayed on the cellular phone 499 to the user 500 that the leading mode is ready. On the cellular phone 499 and in response to the prompt, the user 500 may select a destination, whether to turn a follower proximity function on, and/or whether to switch the self-driving system 100 from the following mode to the leading mode. The user 500 may also select other parameters in response to the prompt, such as an obstacle avoidance mode and a speed for the piece of luggage 102. At block 511, the self-driving system 100 receives user input from the cellular phone 499 of the user 500. The user input includes the user's selections, such as the destination and a decision to switch to the leading mode. The destination may be a location of an airport in which the piece of luggage 102 is located, such as a boarding gate or an information desk.

At block 513, the leading mode is started. The leading mode is started by using the CPU 124 to switch from the following mode to the leading mode. At block 515, the CPU 124 instructs the one or more motorized wheels 106a-106d to move the luggage 102 in a given direction towards the destination of the user input. In the leading mode, the self-driving system 100 instructs the piece of luggage 102 to lead the user 500 to the destination. At block 517, the self-driving system 100 determines if the follower proximity function is on. If the follower proximity function is not on, the piece of luggage 102 proceeds to lead the user 500 to the destination until the piece of luggage 102 arrives at the destination at block 521. If the follower proximity function is on, the self-driving system 100 monitors a proximity of the user 500 relative to the piece of luggage 102 at block 519. In the leading mode, one or more of the sensors 114a-114d (such as the back sensor 114d) and/or one or more of the sensors 120a, 120b (such as the second sensor 120b) may monitor the proximity of the user 500 by taking one or more images of the user 500. One or more of the sensors 114a-114d (such as the front sensor 114b) and/or one or more of the sensors 120a, 120b (such as the first sensor 120a) may monitor the front side 105 of the piece of luggage 102 to avoid obstacles.

The distance D (illustrated in FIGS. 2A and 2C) between the piece of luggage 102 and the user 500 is determined by the CPU 124 at block 519. The distance D may be continuously determined and monitored as the piece of luggage 102 of the self-driving system 100 leads the user 500 to the destination. The CPU 124 sets a first distance level L₁ and a second distance level L₂ that is larger than the first distance level L₁ (illustrated in FIG. 5E). If the distance D is less than the first distance level L₁, then the piece of luggage 102 continues to lead the user 500 at the selected speed. If the distance D is greater than the second distance level L₂, the CPU 124 switches from the leading mode to the following mode at block 523 such that the piece of luggage 102 follows the user 500. If the distance D is between the first distance level L₁ and the second distance level L₂, then the CPU 124 remains in the leading mode and instructs the one or more motorized wheels 106a-106d to slow down or stop such that the piece of luggage 102 slows down or stops until the distance D is less than the first distance level L₁. In one example, the first distance level L₁ is about 1.5 meters and the second distance level L₂ is about 3.0 meters. The first and second distance levels can be adjusted to any distance by the user 500. The piece of luggage 102 then proceeds to lead the user 500 to the destination until the piece of luggage 102 arrives at the destination at block 521. After the piece of luggage 102 arrives at the destination at block 521, the CPU 124 switches from the leading mode to the following mode at block 525.

FIG. 5B is a schematic illustration of block 507 illustrated in FIG. 5A, according to one implementation. Block 507 may include one or more of blocks 527 and/or 537. At block 527, an airport at which the piece of luggage 102 is located is determined. The airport may be determined at block 527 using an onboard module of the piece of luggage 102, such as the positioning module 74 and/or the direct communication module 350 using one or more of 5G data, 4G data, and/or GPS data. The airport may be determined at block 527 using information obtained from the cellular phone 499, such as GPS data. The airport may be determined at block 527 by prompting the user 500 to select an airport on the cellular phone 499.

At block 537, the self-driving system 100 determines if at least one of a vision based navigation or a radio wave based navigation is available for the airport determined at block 527. Determining if the vision based navigation is available includes determining whether a map and a plurality of image feature points of the airport are available, and determining a current location of the piece of luggage 102 using the map and the plurality of image feature points. The determining if the map and the plurality of image feature points of the airport are available includes: determining if the map and the plurality of image feature points are stored in the data storage 320, if the map and plurality of image feature points are not stored in the data storage 320, the map and the plurality of image feature points are downloaded from the remote server 340. In one example, the map and the plurality of image feature points are downloaded through the cellular phone 499 of the user 500.

The determining the current location of the piece of luggage 102 includes taking one or more images 149 using one or more of the cameras 114a-114d and/or one or more of the cameras 120a, 120b. The images 149 include a plurality of image feature points 420. The plurality of image feature points 420 are associated with the downloaded and/or stored plurality of image feature points of a location of the airport to determine the current location of the piece of luggage 102. That is, the downloaded and/or stored plurality of image feature points that match up with the plurality of image feature points 420 correspond to the location that is the current location of the piece of luggage 102.

Determining if the radio wave based navigation is available includes prompting the remote server 340 by asking whether the airport determined at block 527 is supporting radio wave based navigation. If the airport is supporting radio wave based navigation, the remote server 340 will transmit a radio wave signal. The radio wave signal is received and the self-driving system 100 determines if the radio wave signal is sufficient to determine a current location of one or more of the user 500 and/or the piece of luggage 102. If the radio wave signal is sufficient, the current location is determined. If the radio wave signal is insufficient, or if the radio wave signal is not received by the self-driving system 100, then a message is displayed on the cellular phone 499 of the user 500 for the user 500 to move to a new location so that the remote server 340 may be prompted again. The new location is different than the current location. The piece of luggage 102 may also be prompted to move to the new location.

The CPU 124 of the self-driving system 100 may prompt the remote server 340 for the radio wave signal and/or receive the radio wave signal from the remote server 340 using one or more of the cellular phone 499, the direct communication module 350, and/or the positioning module 74.

If the CPU 124 determines that the vision based navigation is available, the vision based navigation is used to navigate the piece of luggage 102 through the airport during the leading mode after the leading mode starts at block 513. If the CPU 124 determines that the radio wave based navigation is available, the radio wave based navigation is used to navigate the piece of luggage 102 through the airport during the leading mode after the leading mode starts at block 513.

If the vision based navigation is used during the leading mode, the back camera 114d may be used to monitor the proximity of the user 500 by taking one or more images 150 of the user 500. The front camera 114b and left and right side cameras 114a, 114c may be used to avoid obstacles and navigate through the airport toward the destination by taking one or more images 419 of the airport. A computer vision based module may be used as the positioning module 74 to navigate through the airport for vision based navigation.

If the radio wave based navigation is used during the leading mode, the back camera 114d may be used to monitor the proximity of the user 500 by taking one or more images 150 of the user 500. The front camera 114b and left and right side cameras 114a, 114c may be used to avoid obstacles by taking one or more images 419 of the airport having the obstacles. A radio wave module, such as a 4G module, 5G module, iBeacon module, and/or Zigbee module, may be used as the positioning module 74 to navigate through the airport for radio wave based navigation.

FIG. 5C is a schematic illustration of a message 530 that may be displayed on the user's cellular phone 499 after the self-driving system 100 is powered on at block 503, according to one implementation. A first portion 531 of the message 530 displays information relating to the self-driving system 100. In the example illustrated in FIG. 5C, the information includes information relating to: the connection status of the self-driving system 100, the current mode (which is defaulted to the following mode at block 505), the type of following mode (such as side following or rear following), and the battery status of the self-driving system 100. A second portion 532 of the message 530 includes one or more prompts. A first prompt 533 prompts the user to take a photograph, for example by using the cameras 114a-114d and/or the cameras 120a, 120b. A second prompt 534 prompts the user to take a video, for example by using the cameras 114a-114d and/or the cameras 120a, 120b. A third portion 535 of the message 530 displays that the CPU 124 is determining whether the one or more leading requirements for the leading mode are met (as described for block 507). The third portion 535 also displays a status bar 536 for the determining of the one or more leading requirements.

FIG. 5D is a schematic illustration of a prompt 538 that may be displayed on the user's cellular phone at block 509, according to one implementation. A first portion 540 of the prompt 538 includes information relating to the current location of the piece of luggage 102, such as the airport determined at block 527 described above. The first portion 540 also includes a list of destinations (for example a boarding gate or information desk within the airport) from which the user 500 selects. A second portion 539 of the message 538 includes a list of selections from which the user 500 can select to turn the follower proximity function on or off. A third portion 541 of the message 538 includes a list of selections from which the user 500 can select a driving speed for the piece of luggage 102. The driving speed for the piece of luggage 102 is the speed at which the piece of luggage 102 leads the user 500 or follows the user 500, depending on whether the self-driving system 100 is in the leading mode or the following mode. A fourth portion 542 of the message 538 includes a list of selections from which the user 500 can select to turn the obstacle avoidance mode on or off. In one example, the piece of luggage 102 stops moving upon detection of an obstacle within a proximity of the piece of luggage 102 if the obstacle avoidance mode is turned off. If the obstacle avoidance mode is turned on, the self-driving system 100 takes corrective action to move the piece of luggage 102 to avoid a collision with an obstacle upon detection of the obstacle within a proximity of the piece of luggage 102. A fifth portion 543 of the message 538 includes a message and/or a prompt. The message may display that the leading mode is ready or not ready, and/or the prompt may prompt the user 500 to switch to the leading mode.

FIG. 5E is a schematic illustration of the self-driving system 100 switching from the leading mode to the following mode while the self-driving system 100 is in the vision monitoring mode, according to one implementation. FIG. 5E illustrates the piece of luggage 102 of the self-driving system 100 moving between a first position 544, a second position 545, and a third position 546. In the first position 544 of the piece of luggage 102, the self-driving system 100 is in the leading mode with the piece of luggage 102 leading the user 500. In the first position 544, the distance D between the user 500 and the piece of luggage 102 is less than the first distance level L₁ (described above), and the piece of luggage 102 continues to lead the user 500 at the selected speed.

FIG. 5E illustrates the user 500 as moving between a first position 547, a second position 548, a third position 549, and a fourth position 550. As the user 500 moves from the first position 547 to the second position 548, the user 500 turns to walk in a different direction. In the second position 545 of the piece of luggage 102 and the second position 548 of the user 500, the distance D is greater than or equal to the first distance level L₁ and less than or equal to the second distance level L₂ (described above), and the piece of luggage 102 slows down or stops to wait for the distance D to become less than the first distance level L₁. As the user 500 continues to walk in a different direction and moves from the second position 548 to the third position 549, the distance D is greater than the second distance level L₂. The distance D being greater than the second distance level L₂ causes the self-driving system to switch from the leading mode to the following mode. The piece of luggage 102 begins to follow the user 500 as the piece of luggage 102 moves from the second position 545 to the third position 546.

Different cameras of the one or more sensors 120a, 120b and/or the one or more sensors 114a-114d may monitor the proximity of the user 500 as the self-driving system 100 switches between the leading mode and the following mode.

For example, the left side camera 114a may be used to monitor the proximity of the user 500 at block 505 in the following mode by taking one or more images of the user 500. At block 505, the piece of luggage 102 may follow the user 500 on a right side of the user 500 such that the left side camera 114a faces the user 500. At block 513, during the leading mode and in the first position 544 illustrated in FIG. 5E, the piece of luggage 102 may move in front of the user 500 to lead the user 500 such that the back camera 114d faces the user 500. The back camera 114d is used to monitor the proximity of the user 500 by taking one or more images of the user 500 during the leading mode. At block 523, for example, the self-driving system 100 switches to the following mode and the piece of luggage 102 moves to a left side of the user 500 such that the right side camera 114c faces the user 500, as illustrated in the third position 546 of the piece of luggage 102 in FIG. 5E. The self-driving system 100 switching from the leading mode to the following mode is illustrated in FIG. 5E as the piece of luggage 102 moves from the second position 545 to the third position 546.

The right side camera 114c is used to monitor the proximity of the user 500 in the following mode by taking one or more images of the user 500 while the front camera 114b, left side camera 114a, and/or back camera 114d may be used for positioning, navigation, and/or obstacle avoidance. In such an example, a first camera (e.g., the back camera 114d) is used by the CPU 124 to monitor the proximity of the user 500 in the leading mode and a second camera (e.g., the right side camera 114c) is used in the following mode.

As the user 500 walks from the third position 549 to the fourth position 550, the front camera 114b faces the user and is used to monitor the proximity of the user 500 while the left side camera 114a, a right side camera 114c, and/or back camera 114d may be used for positioning, navigation, and/or obstacle avoidance.

The leading mode, and the ability to switch between the leading mode and the following mode, of the self-driving system 100 facilitate effectively and efficiently finding destinations in an airport. Benefits of the present disclosure include effectively and efficiently finding destinations, such as boarding gates, in airports; time savings; ease of finding destinations; reduced or eliminated probability of missing a connecting flight; and reduced or eliminated probability of damage to cameras. It is contemplated that one or more of the aspects disclosed herein may be combined. Moreover, it is contemplated that one or more of the aspects disclosed herein may include some or all of the aforementioned benefits.

While the foregoing is directed to embodiments of the present disclosure, other and further embodiments of the present disclosure may be devised without departing from the basic scope thereof. The present disclosure also contemplates that one or more aspects of the embodiments described herein may be substituted in for one or more of the other aspects described. The scope of the present disclosure is determined by the claims that follow.

What is claimed is:

1. A self-driving system, comprising:
a piece of luggage, the piece of luggage comprising one or more motorized wheels; and
a central processing unit configured to:
switch between a following mode and a leading mode, wherein in the following mode the central processing unit instructs the piece of luggage to follow a user, and in the leading mode the central processing unit instructs the piece of luggage to lead the user to a destination.

2. The self-driving system of claim 1, wherein the destination is in an airport.

3. The self-driving system of claim 2, further comprising a data storage configured to store a map and a plurality of image feature points for the airport.

4. The self-driving system of claim 1, wherein the central processing unit monitors a distance between the user and the piece of luggage when in the leading mode.

5. The self-driving system of claim 4, wherein the central processing unit instructs the piece of luggage to slow down or stop if the distance is greater than or equal to a first distance level and less than or equal to a second distance level, and the central processing unit switches from the leading mode to the following mode if the distance is greater than the second distance level.

6. The self-driving system of claim 4, wherein the central processing unit monitors the distance using one or more cameras configured to take one or more images of the user.

7. The self-driving system of claim 6, wherein the central processing unit monitors the distance using a first camera in the leading mode, and the central processing unit monitors the distance using a second camera in the following mode.

8. The self-driving system of claim 1, wherein the central processing unit defaults to the following mode.

9. The self-driving system of claim 8, wherein the central processing unit switches to the leading mode in response to user input received from a cellular phone.

10. A method of operating a self-driving system, comprising:
defaulting to a following mode for a piece of luggage;
determining if one or more leading requirements are met for a leading mode;
starting the leading mode; and
moving the piece of luggage toward a destination.

11. The method of claim 10, further comprising:
determining if a follower proximity function is on; and
monitoring a proximity of a user, the monitoring the proximity of the user comprising determining a distance between the piece of luggage and a user.

12. The method of claim 10, further comprising, prior to the starting the leading mode:
prompting a user to switch from the following mode to the leading mode; and
receiving user input.

13. The method of claim 12, wherein the user input comprises the destination.

14. The method of claim 13, wherein the determining if one or more leading requirements are met for the leading mode comprises:
determining an airport at which the piece of luggage is located; and
determining if at least one of a vision based navigation or a radio wave based navigation is available at the airport.

15. The method of claim 14, wherein the destination is a location within the airport.

16. The method of claim 14, wherein the determining if the vision based navigation is available comprises:
determining if a map and a plurality of image feature points of the airport are available; and
determining a current location of the piece of luggage using the map and the plurality of image feature points.

17. The method of claim 16, wherein the determining if the map and the plurality of image feature points of the airport are available comprises:
determining if the map and the plurality of image feature points are stored in a data storage; and
downloading the map and the plurality of image feature points from a remote server if the map and the plurality of image feature points are not stored in the data storage.

18. The method of claim 14, wherein the determining if the radio wave based navigation is available comprises:
prompting a remote server;
receiving a radio wave signal from the remote server; and
determining if the radio wave signal is sufficient to determine a current location of one or more of the user or the piece of luggage.

19. The method of claim 18, further comprising:
prompting one or more of the user or the piece of luggage to move to a new location that is different than the current location.
